(19) United States
(12) Patent Application Publication
(10) Pub. No.: US 2025/0161845 A1
(43) Pub. Date: May 22, 2025

(54) Filter for a Fluid Passageway

(71) Applicant: Robert Bosch GmbH, Stuttgart (DE)

(72) Inventor: George Popovici, Woburn, MA (US)

(21) Appl. No.: 18/514,208

(22) Filed: Nov. 20, 2023

(51) Int. Cl. B01D 21/00

(52) U.S. Cl. CPC B01D 21/0012; B01D 21/0039

(57) ABSTRACT

A fluid delivery system includes a fluid passageway having a discontinuity that results in a particle settlement area downstream of the discontinuity. A settlement filter is provided in the system. The settlement filter includes the discontinuity and a sieve that coincides with the particle settlement area. The fluid delivery system also includes a particle trap that underlies the sieve and is configured to receive and trap particles that settle from fluid flowing through the fluid passageway.

### BACKGROUND

Cooling systems used in buildings and vehicles may be a complex aggregation of multiple components which are interconnected via fluid passageways. As used herein, the term “components” refers to devices that contact the fluid passing through the cooling system including pumps, valves, filters, heat exchangers, hoses, pipes, bottles, reservoirs, and any cooling channel in a component through which coolant is routed. A cooling system may operate by passing a fluid (e.g., a coolant) through the fluid passageways between the appropriate components.

During the manufacture of the system components, various manufacturing processes may leave behind deleterious contaminants that subsequently contaminate the coolant. Typical contaminants include sand, metal dust and metal chips. The sand may be a remnant of a casting process or may have been used during manufacturing to abrasively remove component material. The metal dust may be a remnant of a grinding process, and the metal chips may be a remnant of a cutting process. Each of these contaminants are solids, generally abrasive, and of density significantly greater than the fluid coolant of, for example, a typical automotive coolant mixture.

Once introduced into the assembled cooling system, such solid contaminants may be carried along with the flowing coolant and may contact all the components in the cooling system. Such contaminants can negatively affect the components due to abrasive wear and clogging of cooling channels. In some cases, these undesirable effects may lead to premature component failure and decreased system efficiency. It is desirable to remove contaminants from the fluid of a cooling system.

### SUMMARY

Referring to FIGS. 1 and 2, the amount of solid contaminant such as particles or other debris carried by the coolant is a function of the local coolant velocity, the size of the contaminant particle, and the density ratio between the fluid coolant and the solid particle. All other things being equal, a faster moving fluid is more able to keep a given particle in suspension than a slower moving fluid. In addition, when the fluid is at zero velocity, all particles that are more dense than the coolant will fall under force of gravity and settle at the lowest surface of the fluid passageway.

In any fluid path when the velocity of the fluid in the path is greater than zero, a secondary flow appears in addition to the main (primary) flow of fluid in the path. In particular, in a fluid pipe having a surface discontinuity such as a protrusion, a step change in passageway diameter or a passageway corner, an eddy or secondary flow may be created at the discontinuity by the primary flow as it passes the discontinuity. Particles that are entrained in the fluid and which find themselves at the boundary between the primary flow and the secondary flow, are subjected to forces from each of the primary flow and secondary flow. In effect, the local velocity of the primary and secondary flows may approach zero in boundary areas. As consequence, as shown in FIGS. 1 and 2, solid particles entrained in the fluid may drop from suspension. For convenience, the locations immediately downstream of a discontinuity in the flow path will be referred to as “settlement areas.” The precise location and the size of a settlement area is dependent on flow rate, viscosity of the fluid, and the difference in density between the carrying fluid and the solid particles.

A settlement filter is provided in a fluid passageway of an automotive cooling system that is configured to take advantage of these fluid flow and particle settling characteristics to remove particle contaminants from a fluid coolant. The settlement filter may include a portion of the fluid passageway having a discontinuity and a sieve that is provided in a floor of the fluid passageway in the settlement area of the discontinuity. As used herein, the term “floor” corresponds to the lowermost portion of the fluid passage with respect to the direction of gravity of the earth. The sieve includes perforations referred to as “trap openings” that are provided in the floor and are configured to allow passage of particles therethrough under force of gravity. The particles that drop from suspension sink to the floor and may pass through the trap openings. The settlement filter may also include a filter housing that defines a settling chamber below the trap openings. The particles become trapped in the settling chamber, which prevents the particles from becoming re-entrained in the fluid flow.

The settlement areas can be created in a controlled manner by intentional placement of a discontinuity in a desired location within the flow path. For example, a discontinuity may be embodied as a sharp transition of the flow path's cross section shape. In one embodiment, the settlement filter includes a flow passage having a first cross-sectional shape (for example, a round cross-sectional shape) that is transitioned to a second cross-sectional shape (in this example, a rectangular cross-sectional shape). The corners that are found at the transition between the different cross-sections may result in a secondary flow and provide a settlement area. In addition, the increased passageway volume downstream of the transition results in reduced flow velocity, further contributing to the settling of particles from the fluid flow.

By placing a sieve in the settlement area, solid contaminants of greater density than the carrying medium may be removed from the flowing fluid, thus improving reliability, increasing the durability, life and efficiency of the fluid delivery system and the individual components of the system.

In some aspects, a fluid delivery system includes a fluid passageway and a settlement filter disposed in the fluid passageway. The fluid passageway includes a first passageway portion having a first cross-section, and a second passageway portion having a second cross-section where the first cross-section and the second-cross section are perpendicular to a direction of fluid flow through the fluid passageway. The second passageway portion adjoins the first passageway portion and is downstream of the first passageway portion with respect to the direction of fluid flow through the fluid passageway. The settlement filter includes a transition from the first passageway portion to the second passageway portion and is configured to receive and retain particles therein. The transition is a result of the first cross-section having a first shape, the second cross-section having a second shape, and the first shape being different than the second shape.

In some embodiments, the first cross-section has a first area, the second cross-section has a second area, and the first area is less than the second area.

In some embodiments, the first cross-section is circular and the second-cross section is rectangular.

In some embodiments, the fluid passageway includes a first floor portion corresponding to the lowermost portion of the first passageway portion with respect to the direction of gravity of the earth. The fluid passageway includes a second floor portion corresponding to the lowermost portion of the second passageway portion with respect to the direction of gravity of the earth. The first floor portion and the second floor portion are flush so as to form a continuous straight line.

In some embodiments, the first floor portion and the second floor portion reside in a plane that is angled relative to the horizontal in a range of (+) 45 degrees to (−) 35 degrees.

In some embodiments, the transition between the first passageway portion and the second passageway portion defines a corner.

In some embodiments, the transition between the first passageway portion and the second passageway portion defines a corner.

In some embodiments, the filter is comprised of trap openings that are formed in a surface of the second passageway portion, and each trap opening is configured to allow passage of particles therethrough under force of gravity.

In some embodiments, the fluid passageway defines a floor corresponding to the lowermost portion of the fluid passageway with respect to the direction of gravity of the earth, and the filter comprises trap openings defined by the floor and configured to allow passage of particles therethrough under force of gravity.

In some embodiments, the fluid passageway is defined by an inner surface of the housing. The fluid passageway defines a floor corresponding to the lowermost portion of the fluid passageway with respect to the direction of gravity of the earth. The filter comprises trap openings that are provided in the floor and are configured to allow passage of particles therethrough under force of gravity. The housing comprises a vacancy that underlies the trap openings, and the vacancy is configured to receive and retain particles that pass through the trap openings.

In some aspects, a fluid delivery system includes a fluid passageway and a settlement filter disposed in the fluid passageway. The fluid passageway includes a first passageway portion having a first cross-section, and a second passageway portion having a second cross-section. The second passageway portion adjoins the first passageway portion and is downstream of the first passageway portion with respect to the direction of fluid flow through the fluid passageway. The settlement filter includes a transition from the first passageway portion to the second passageway portion and is configured to receive and retain particles therein. The first cross-section is different from the second cross section in shape or dimension, the difference in the first cross-section and the second cross section defining the transition, and the fluid passageway defines a floor corresponding to the lowermost portion of the fluid passageway with respect to the direction of gravity of the earth. The settlement filter comprises a sieve disposed in the floor of the second passageway portion, and the sieve is configured to allow passage of particles therethrough under force of gravity.

In some embodiments, the sieve is disposed at the transition from the first passageway portion to the second passageway portion and is includes trap openings.

In some embodiments, the settlement filter includes a trap housing that receives particles that have passed through the trap openings, the trap housing configured to retain particles received therein.

In some embodiments, the trap housing underlies the trap openings with respect to a direction of the force of gravity.

In some embodiments, the first cross-section has a first shape, the second cross-section has a second shape, and the first shape is different than the second shape.

In some embodiments, the first cross-section is circular and the second-cross section is rectangular.

In some embodiments, the floor includes a first floor portion corresponding to the lowermost portion of the first passageway portion with respect to the direction of gravity of the earth, the floor includes a second floor portion corresponding to the lowermost portion of the second passageway portion with respect to the direction of gravity of the earth, and the first floor portion and the second floor portion are flush so as to form a continuous straight line.

In some embodiments, the first floor portion and the second floor portion reside in a plane that is angled relative to the horizontal in a range of (+) 45 degrees to (−) 35 degrees.

In some embodiments, the system includes a housing wherein the fluid passageway is defined by an inner surface of the housing.

The settlement filter is advantageous when compared to some conventional in-line porous-medium filters used to capture contamination. For example, the settlement filter does not create a pressure drop since it does not obstruct the way. In addition, the settlement filter does not create an increasing pressure drop as the filter media traps increasing quantities of contamination, as may be the case in the in-line porous medium filters.

### BRIEF DESCRIPTION OF THE FIGURES

FIG. 1 is a graph illustrating the relationship between the ability of a fluid to carry particles versus the fluid velocity.

FIG. 2 is a graph illustrating the relationship between the ability of a fluid to carry particles and the ratio of particle density to fluid density.

FIG. 3 is a schematic illustration of a thermal management system that includes a refrigerant subsystem (shown in broken lines) and a coolant subsystem (shown in solid lines), the coolant subsystem including filter in a primary fluid passageway of the coolant subsystem.

FIG. 4 is a perspective view of the fluid passageway with a passageway cover omitted to make visible the passageway discontinuity, the resulting settlement area and the filter disposed therein. In FIG. 4, the direction of fluid flow through the fluid passageway is indicated by the solid arrow.

FIG. 5 is a cross-sectional view of the fluid passageway as seen along line 5-5 of FIG. 4. In FIG. 5, the direction of fluid flow through the fluid passageway is indicated by the solid arrow.

FIG. 6 is a cross-sectional view of the fluid passageway as seen along line 6-6 of FIG. 4. In FIG. 6, the direction of fluid flow through the fluid passageway is indicated by the solid arrow.

FIG. 7 is a cross-sectional view of the fluid passageway as seen along line 7-7 of FIG. 5 illustrating the cross-section of the first passageway portion.

FIG. 8 is a cross-sectional view of the fluid passageway as seen along line 8-8 of FIG. 5 illustrating the cross-section of the second passageway portion.

FIG. 9 is a diagram illustrating the angular range of possible orientations of the filter relative to the horizontal in which the filter may be most effective.

FIG. 10 is a schematic illustration of an alternative embodiment fluid passageway including a filter in the settlement area of the fluid passageway.

FIG. 11 is a schematic illustration of another alternative embodiment fluid passageway including a filter in the settlement area of the fluid passageway.

FIG. 12 is a schematic illustration of another alternative embodiment fluid passageway including a filter in the settlement area of the fluid passageway.

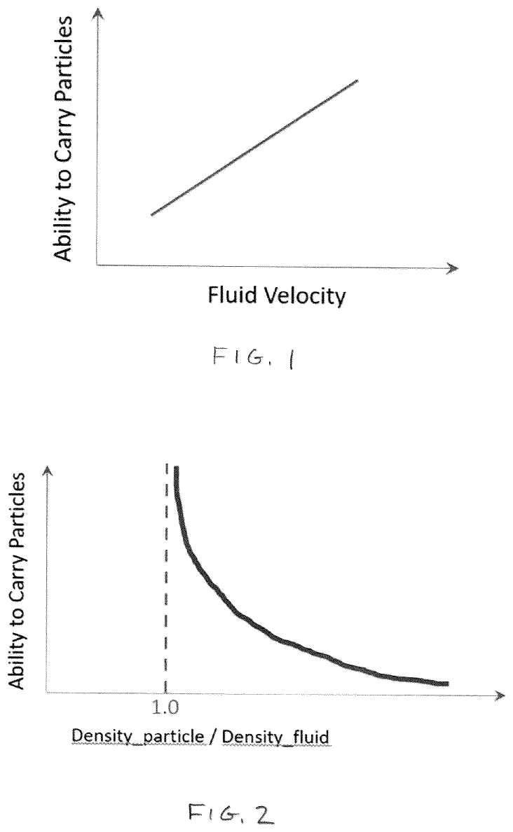

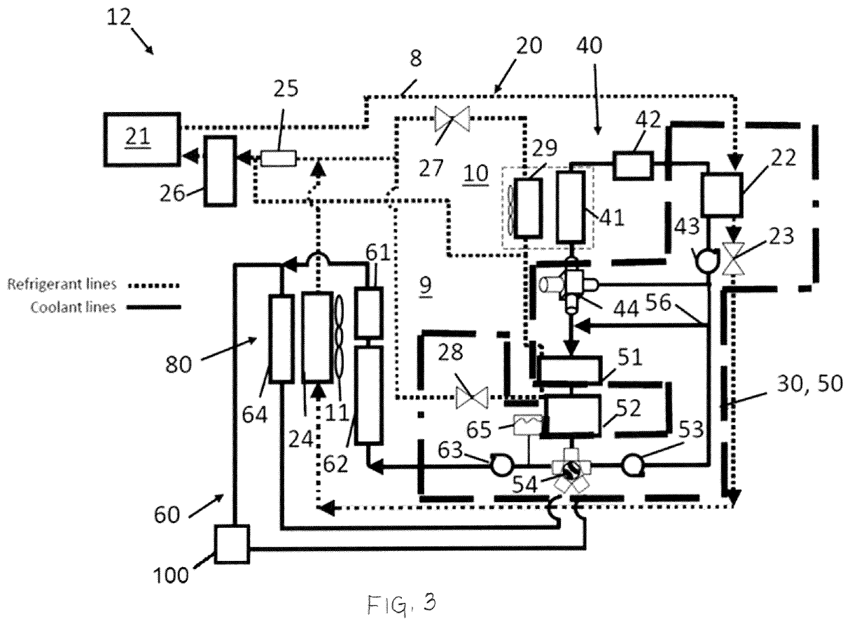

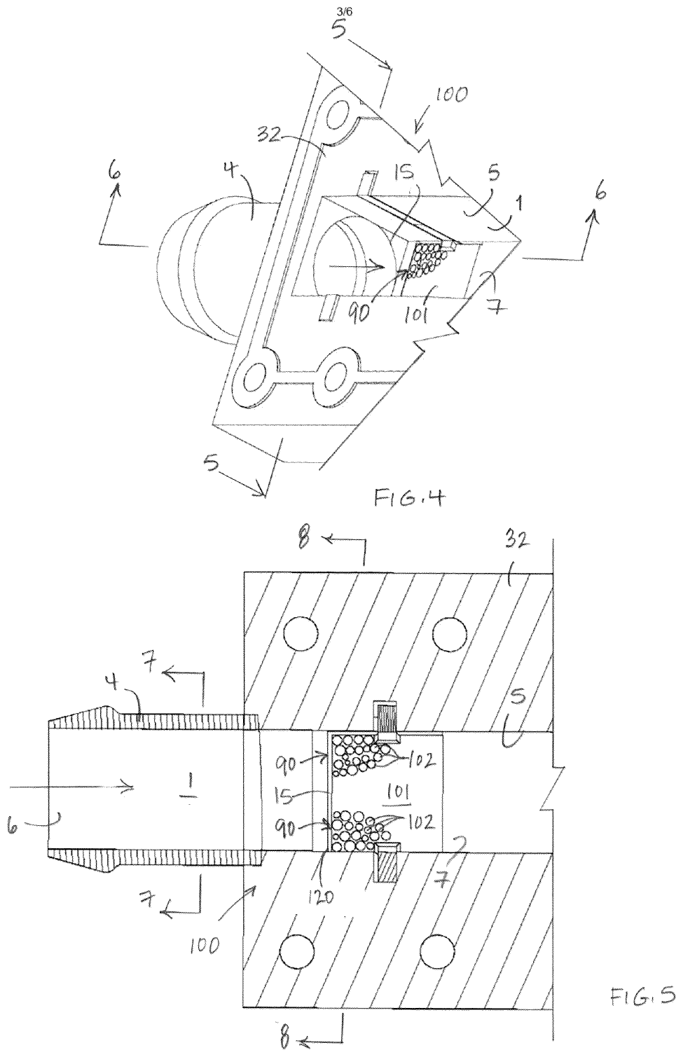

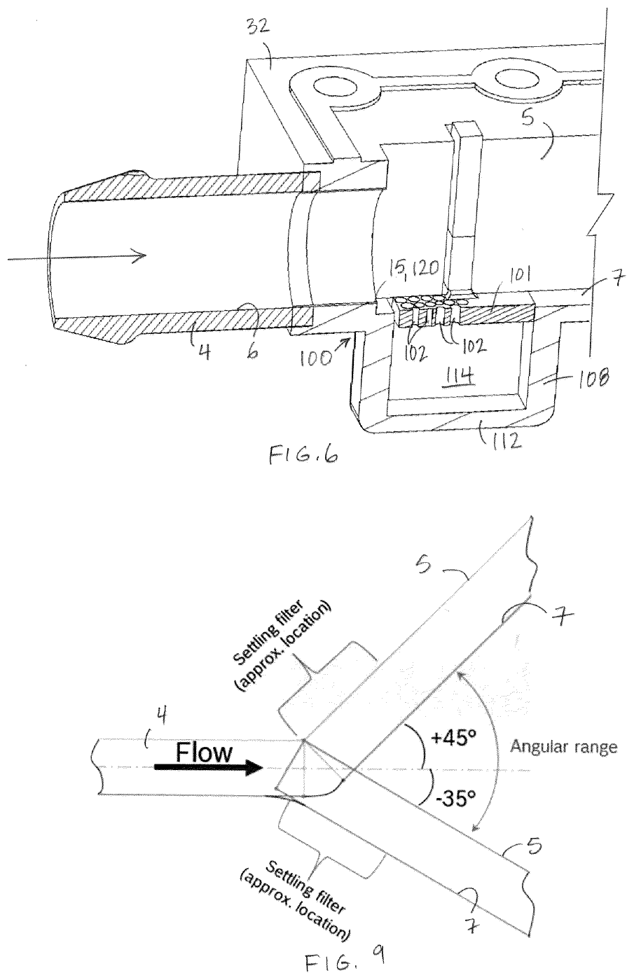

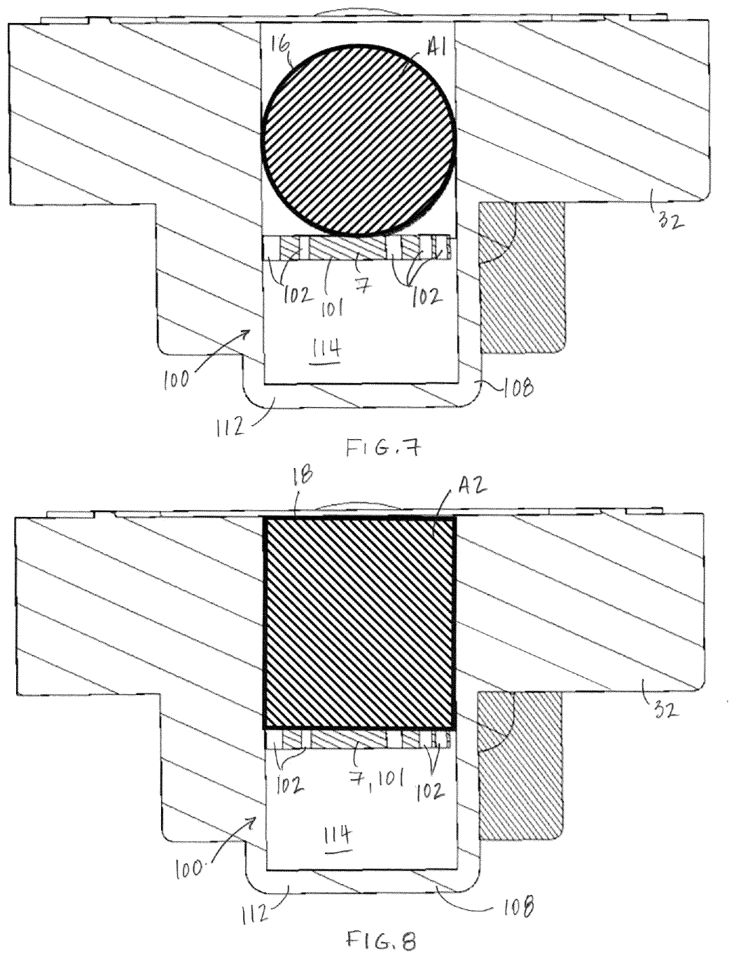

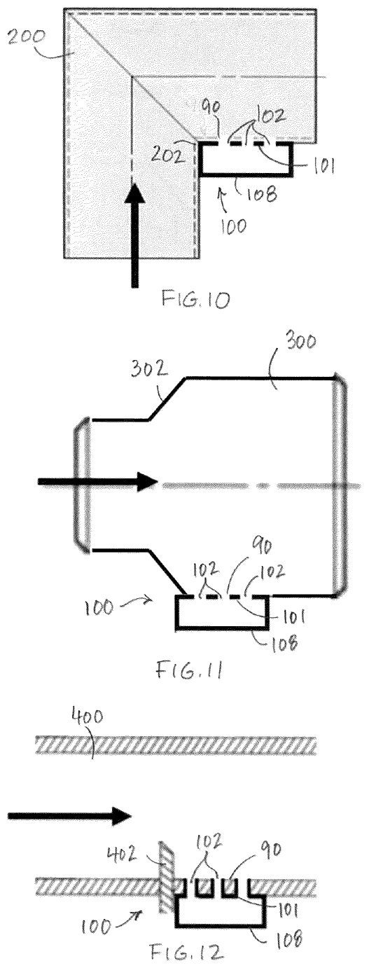

### DETAILED DESCRIPTION

Referring to FIG. 3, a thermal management system 12 for an electric vehicle (not shown) includes a closed-loop refrigerant subsystem 20 and a closed-loop coolant subsystem 30. Each of the refrigerant subsystem 20 and the coolant subsystem 30 include multiple components which are interconnected via fluid passageways 1. The fluid passageways 1 may be arranged into circuits or loops 8, 9, 10, 40, 50, 60 and may be constituted of piping or hoses. Alternatively, the fluid passageways 1 may be channels formed in components or ancillary structures through which fluid is routed. In some embodiments of the thermal management system 12, the fluid passageways 1 may be a combination of piping, hoses and/or channels. In the coolant subsystem 30, cooling of the components is achieved by passing the fluid (e.g., coolant) through the fluid passageways 1 and the components that are connected by the fluid passageways 1. In the coolant subsystem 30, at least one settlement filter 100 is provided in at least one of the fluid passageways 1 for removing particles from the coolant. The settlement filter 100 will be described in detail below.

The electric vehicle may be a battery-electric (i.e., all electric) vehicle (BEV), a plug-in hybrid electric vehicle (PHEV), or a hybrid electric vehicle (HEV). As such, the electric vehicle may include at least one electric traction motor for propulsion of the vehicle. For example, the electric traction motor can be mechanically coupled directly or indirectly to rotate one or more wheels of the vehicle. The electric vehicle may in some constructions include a combustion engine. However, in partial- or full-electric driving modes, drive power requirements from the combustion engine are reduced or eliminated. In other constructions, the electric vehicle has no combustion engine operable for propulsion of the vehicle.

To power the electric traction motor, a traction battery is included in the vehicle. The traction battery may be a high voltage battery (e.g., greater than 100 Volts) and may require cooling or heating under certain circumstances. The traction motor, the wheels and the associated controller and power electronics are referred to herein as the vehicle drivetrain. In addition, a cabin of the vehicle that houses vehicle occupants may be provided with climate control for occupant comfort.

The thermal management system 12 includes a closed-loop refrigerant subsystem 20 and the closed-loop coolant subsystem 30. The refrigerant subsystem 20 provides a vapor-compression refrigeration cycle upon a working fluid, or “refrigerant”. The refrigerant subsystem 20 facilitates thermal management of the vehicle drivetrain via a condenser 22 that provides heat transfer to or from ambient space, and also interfaces with the coolant subsystem 30. The coolant subsystem 30 employs one or more proportional valves 44, 54 to selectively combine vehicle drivetrain thermal management via a vehicle drivetrain coolant loop 60, traction battery thermal management via a battery coolant loop 50 and cabin thermal management (e.g., climate control) via a cabin coolant loop 40. Operation of the thermal management system 12 depends upon vehicle operating conditions, ambient conditions, and climate control requirements of the cabin occupant(s). The refrigerant and coolant subsystems 20, 30 of the thermal management system 12 will now be described in detail.

The refrigerant subsystem 20 includes compressor 21. In some embodiments, the compressor 21 may be an electric compressor. The compressor 21 outputs hot refrigerant to a liquid cooled condenser (LCC) 22, which transfers some heat from the refrigerant to the cabin coolant loop 40. The LCC 22 outputs slightly cooled refrigerant to a first expansion valve 23. The first expansion valve 23 may be an electronic expansion valve (EEV) that can selectively be changed between an expansion mode in which fluid passing therethrough is expanded (cooled) and a fully-open mode in which fluid passing therethrough is unchanged. Unless otherwise indicated, the first EEV 23 is operated in the expansion mode. The first EEV 23 outputs a cold refrigerant, which is directed to a front heat exchanger 24 that is part of an engine cooling fan package 80. The engine cooling fan package 80 includes the front heat exchanger 24, a drive heat exchanger 64 (i.e., a radiator that is part of the drivetrain coolant loop 60) and an engine cooling fan 11 in a stacked arrangement that is typically located immediately behind the front grille (not shown) of a vehicle. The front heat exchanger 24 may transfer heat to the refrigerant, and thus outputs cool refrigerant to the compressor 21 via a shut-off valve (SOV) 25 and an accumulator 26. The compressor 21, the LCC 22, the first EEV 23, the front heat exchanger 24 and the accumulator 26 constitute a main refrigerant loop 8.

The refrigerant subsystem 20 can be controlled to redirect at least some refrigerant to other vehicle components, depending on the configuration of the respective components and the SOV 25. To this end, the refrigerant subsystem 20 includes a first sub-loop 9 in which refrigerant from the front heat exchanger 24 is directed to a second electronic expansion valve 28 prior to passing through the refrigerant side of the battery heat exchanger 51, where it cools the coolant of the battery coolant loop 50 and is then directed to the accumulator 26 and compressor 21, thus returning to the main refrigerant loop 8. In addition, the refrigerant subsystem 20 includes a second sub-loop 10 in which refrigerant from the front heat exchanger 24 is directed to a solenoid thermostatic expansion valve (TXV) 27. Cooled refrigerant exiting from the TXV 27 is directed to an evaporator 29 associated with a cabin heat exchanger 41 of the cabin coolant loop 40. A blower may draw air over both the evaporator 29 and the cabin heat exchanger 41 and into the cabin, bringing hot air in the case of a hot cabin heat exchanger 41 or cool air in the case of a relatively cold evaporator 29. Refrigerant exiting the evaporator 29 is directed to the accumulator 26 and the compressor 21, thus returning to the main refrigerant loop. Depending on the configuration of the respective components, refrigerant may flow through the first sub-loop 9 and not the second sub-loop 10, refrigerant may flow through the second sub-loop 10 and not the first sub-loop 9, or refrigerant may flow through both the first and second sub-loops 9, 10.

The refrigerant used in the refrigerant subsystem 20 is a substance suitable for use in a heat cycle is capable of undergoing a phase change between gas and liquid to allow cooling. For example, in some embodiments, the refrigerant used in the refrigerant subsystem 20 is R1234YF.

The coolant subsystem 30 includes the vehicle drivetrain coolant loop 60, the battery coolant loop 50 and the cabin coolant loop 40 which are selectively combined via proportional valves 44, 54 as required by operating conditions.

The cabin coolant loop 40 includes a first pump 43 that drives coolant fluid through the coolant subsystem 30. Coolant exiting the first pump 43 enters the coolant side of the LCC 22. Heat may be transferred to the coolant within the LCC 22 so that the temperature of the coolant exiting the LCC 22 is greater than the temperature of the coolant exiting the first pump 43. The coolant exiting the LCC 22 is directed to a positive temperature coefficient heater (PTC) 42, where additional heat may be added to the coolant. Thus, the temperature of the coolant exiting the PTC 42 is greater than the temperature of the coolant exiting the LCC 22. The LCC 22 and PTC 42 are in series, which allows for both components to simultaneously contribute heat to the cabin coolant loop 40. The cabin coolant loop 40 includes the cabin heat exchanger 41 that cooperates with the refrigerant cooled evaporator 29 and a blower to effect climate control of the vehicle cabin. For example, due to the relatively high temperature of the coolant flowing through the cabin heat exchanger 41, the temperature within the vehicle cabin may be increased if desired by the vehicle occupants. As discussed previously, refrigerant exiting the evaporator 29 is directed to the accumulator 26 and the compressor 21, thus returning to the main refrigerant loop 8.

Coolant exiting the cabin heat exchanger 41 is directed to a port of a first fluid control valve. In the illustrated embodiment, the first fluid control valve is a four-port coolant proportional valve (CPV) 44, and the coolant exiting the cabin heat exchanger 41 is directed to the first port of the CPV 44. The inlet of the first pump 43 is connected to the second port of the CPV 44, and the third port of the CPV 44 is connected to the battery coolant loop 50, and particularly to an inlet of coolant side of the battery heat exchanger 51.

The battery coolant loop 50 includes the battery heat exchanger 51. The refrigerant side of the battery heat exchanger 51 is part of the first sub-loop of the refrigerant subsystem 20. Coolant exiting the battery heat exchanger 51 is directed to the battery 52, where it is used to cool individual electrochemical cells of the battery 52. Coolant exiting the battery 52 is directed to a port of a second fluid control valve. In the illustrated embodiment, the second fluid control valve is a five-port coolant proportional valve (CPV) 54, and the coolant exiting the battery 52 is directed to the first port of the five-port CPV 54. The battery coolant loop 50 includes a second pump 53, which is connected to a second port of the five-port CPV 54. The second pump 53 drives coolant fluid through the coolant subsystem 30 and is connected to an inlet of the first pump 43. The second pump 53 is also connected to the outlet of the third port of the four-port CPV 44 via a bypass line 56.

The vehicle drivetrain coolant loop 60 includes a third pump 63 that is fed from a reservoir 65. The inlet of the third pump 63 is connected to the fifth port of the five-port CPV 54. The outlet of the third pump 63 is connected to the vehicle power electronics 62, which may include, but is not limited to, a DC-DC converter and an on-board charger (OBC). Coolant exiting the power electronics 62 is directed to an e-axle 61. The e-axle 61 is a compact modular unit that includes the electric traction motor, electronics and the transmission that power the vehicle's axle. Depending on system requirements, the coolant exiting the e-axle 61 may be returned to the fourth port of the 5-port CPV 54 via the drive heat exchanger 64 of the engine cooling fan package 80, or alternatively may be returned to the third port of the 5-port CPV 54 while bypassing the drive heat exchanger 64.

The coolant used in the coolant subsystem 30 is a substance suitable for use in a vehicle cooling system. For example, in some embodiments, the coolant is a mixture of water and ethylene glycol or a mixture of the two.

The components of the coolant subsystem 30 are interconnected via the fluid passageways 1 that are used to define the loops 40, 50, 60 of the coolant subsystem 30. In the illustrated embodiment, the fluid passageway 1 is defined by an internal surface of a housing 32 of a component of the coolant subsystem 30. A settlement filter 100 is provided in at least one fluid passageway 1 of the coolant subsystem 30 that is configured to take advantage of the fluid flow and particle settling characteristics described above to remove particle contaminants from the fluid coolant.

Referring to FIGS. 4-8, the settlement filter 100 may include a portion of the fluid passageway 1 having a discontinuity 120. In addition, the settlement filter 100 may include a sieve 101 that is provided in a floor 7 of the fluid passageway 1 in the settlement area 90 of the discontinuity 120. The location and the size of the settlement area 90 depends on the flow rate of the fluid, the viscosity of the fluid and the difference in the density between the fluid and the solid particles being carried therein. Settlement areas 90 can be created by intentional placement of the discontinuity 120 in the fluid passageway 1. For example, in the illustrated embodiment, the discontinuity 120 employed to provide a transition within the fluid passageway 1 is a change in cross-sectional shape of the fluid passageway 1. In particular, the fluid passageway 1 includes a first passageway portion 4 having a first cross-section and a second passageway portion 5 having a second cross-section. As used herein, the term “cross-section” when used with reference to the fluid passageway 1 or portions 4, 5 thereof refers to a cross-section that is perpendicular to a direction of fluid flow through the fluid passageway 1. The second passageway portion 5 adjoins and thus is serially arranged with respect to the first passageway portion 4. In addition, the second passageway portion 5 is fluidly connected to the first passageway portion 4.

The first passageway portion 4 is a cylindrical tube and the second passageway portion 5 is rectangular tube, and a sharp transition for example a corner 15 exists between the first passageway portion 4 and the second passageway portion 5. Thus, the corner 15 that is found at the transition between the cross-sections of the first and second passageway portions 4, 5 provides the discontinuity 120 that produces a secondary flow and provides the settlement area 90 within the second passageway portion 5 immediately downstream of the transition. In this exemplary embodiment, the first passageway portion 4 has a first cross-section 16, and the first cross-section 16 has a first shape (e.g., a circular shape) and a first area A1 (FIG. 7). In addition, the second passageway portion 5 has a second cross-section 18, and the second cross-section 18 has a second shape (e.g., a rectangular shape) and a second area A2 (FIG. 8). In this embodiment, the first shape is different from the second shape and the first area A1 is less than the second area A2. As a result of this change-in-shape discontinuity, particle settlement may occur even if the second area A2 is equal to or slightly larger than the first area A1.

The sieve 101 is provided in the floor 7 of the second passageway portion 5 within the settlement area 90. By this configuration, the sieve 101 adjoins the transition between the first and second passageway portions 4, 5. In addition, the floor 6 of the first passageway portion 4 and the floor 7 of the second passageway portion 5 are flush so as be colinear along at least one line that includes the floors 6, 7 of both the first and second passageway portion 4, 5. The sieve 101 includes the floor 7 in the settlement area 90 and the trap openings 102 formed in the floor 7.

In addition, the settling filter 100 includes a particle trap 108 that underlies the trap openings 102. The trap openings 102 receive the particles that settle under force of gravity within settlement area 90 to the floor 7 due to the relatively low or zero fluid flow velocity within the settlement area 90. The particle trap 108 retains the particles that pass through the trap openings 102.

The trap openings 102 are through-openings provided in the floor 7 and are configured to allow passage of particles therethrough under force of gravity. In particular, the second passageway portion 5 has the floor 7 that defines secondary trap openings 102, and each secondary trap opening 102 is configured to allow passage of particles therethrough under force of gravity. Although the trap openings 102 are illustrated herein as having a circular shape, the trap openings 102 are not limited to this shape. Although the trap openings 102 are illustrated herein as having a uniform size, the trap openings 102 are not limited to having a uniform size. In some embodiments, the trap openings 102 may be formed in the floor 7 for example by drilling or etching. In other embodiments, the trap openings 102 may be provided by replacing the floor 7 within the settlement area 90 with a mesh screen or other filtering device.

The particle trap 108 includes a filter housing 112 that underlies the floor 7 of the second passageway portion 5. In the illustrated embodiment, the filter housing 112 underlies only the portion of the floor 7 corresponding to the settlement area 90 (e.g., the filter housing 112 underlies the sieve 101) but is not limited to this configuration. By this configuration, the filter housing 112 encloses the settlement area 90 including the trap openings 102. The trap openings 102 provide fluid communication between the second passageway portion 5 and an interior space 114 of the filter housing 112. When a suspended particle drops from the fluid and settles under force of gravity on the floor 7, it may pass through one of the respective trap openings 102 and into the housing interior space 114. Since the housing interior space 114 is out of the path of fluid flow, the filter housing 112 provides an enclosure that receives and retains the particles that pass through the trap openings 102. By this configuration, the particles disposed in the housing interior space are resistant to re-entrainment.

The filter 100 is configured to take advantage of settling characteristics of particles suspended in the fluid within the fluid passageway 1 of the coolant subsystem 30 and to remove particle contaminants from the fluid. The efficiency of the filter 100 is optimized when the filter 100 is located in a portion of the fluid-flow system that is substantially horizontal so that gravity forces can drive the settled particles into the particle trap 108 and retain the particles therein. Although the filter 100 may be placed at locations where the primary fluid passageway is inclined as much as 45 degrees or declined as much as 35 (FIG. 9), the efficiency of the filter 100 may be lower than compared to a horizontal or substantially horizontal location.

Although the filter 100 has been described herein as being used in a cooling system of an electric vehicle, the filter 100 may be used in any cooling system and is not limited to being used in any type of vehicle. In particular, the filter may be used in the cooling system of an electric vehicle, a hybrid vehicle or a vehicle powered by an internal combustion engine.

The filter 100 is not limited to being used in the cooling system of a vehicle and can be used in other applications such as the cooling systems of buildings or devices. Moreover, the filter is not limited to being used in a cooling system and may be employed in any fluid system.

The first passageway portion 4 is described herein as being a cylindrical tube, and thus has a circular cross-sectional shape while the second passageway portion 5 is described herein as being a rectangular tube and thus has a rectangular cross-sectional shape. However, the first and second passageway portions 4, 5 are not limited to these shapes. For example, in some embodiments, the first passageway portion 4 may have other closed, curved shapes such as elliptical or squared circle. Likewise, in some embodiments, the second passageway portion 5 may have the shape of a square or rounded rectangle.

The discontinuity described herein is a transition between passageway portions having different cross-sectional shapes. However, the discontinuity is not limited to this, and may be implemented in other forms. FIGS. 10-12 illustrate some non-limiting examples of discontinuities in fluid passageways that can be used to generate settlement areas 90 and implement the filter 100.

Referring to FIG. 10, an alternative embodiment passageway 200 includes a discontinuity in the form of a corner 202 resulting from a 90 degree direction change in the fluid passageway 200. The settlement area 90 occurs on the downstream side of the corner 202, and the sieve 101 is located on the downstream side of the corner 202 and adjoins the corner.

Referring to FIG. 11, another alternative embodiment passageway 300 is cylindrical and includes a discontinuity 302 resulting from a sharply tapered diameter change in the fluid passageway 300. In a manner similar to the embodiment shown in FIGS. 4-6, the diameter change is from a smaller diameter to a larger diameter, and the diameter change occurs over a short distance relative to the length of the passageway. The settlement area 90 occurs on the downstream side of the discontinuity 302, and the sieve 101 is located at the settlement area 90 on the downstream side of the discontinuity 302.

Referring to FIG. 12, another alternative embodiment passageway 400 includes a discontinuity in the form of a semi-annular annular protrusion 402 that protrudes radially inward from an inner surface of the passageway 400. In these embodiments, the settlement area 90 occurs on the downstream side of the annular protrusion. For this reason, the sieve 101 is located on the downstream side of the annular protrusion 402 and adjoins the annular protrusion 402.

Selective illustrative embodiments of the cooling system including the fluid filter are described above in some detail. Only structures considered necessary for clarifying the cooling system and the fluid filter have been described herein. Other conventional structures, and those of ancillary and auxiliary components of the cooling system and the fluid filter are assumed to be known and understood by those skilled in the art. Moreover, while a working example of the cooling system and the fluid filter have been described above, the cooling system and the fluid filter are not limited to the working example described above, but various design alterations may be carried out without departing from the cooling system and the fluid filter as set forth in the claims.

We claim:

1. A fluid delivery system, comprising:
a fluid passageway including
a first passageway portion having a first cross-section, and
a second passageway portion having a second cross-section, the second passageway portion adjoining the first passageway portion and being downstream of the first passageway portion with respect to the direction of fluid flow through the fluid passageway; and
a settlement filter that is disposed in the fluid passageway, the settlement filter comprising a transition from the first passageway portion to the second passageway portion and being configured to receive and retain particles therein,
wherein
the first cross-section and the second-cross section are perpendicular to a direction of fluid flow through the fluid passageway, and
the transition is a result of the first cross-section having a first shape, the second cross-section having a second shape, and the first shape being different than the second shape.

2. The fluid delivery system of claim 1, wherein
the first cross-section has a first area,
the second cross-section has a second area, and
the first area is less than the second area.

3. The fluid delivery system of claim 1, wherein the first cross-section is circular and the second-cross section is rectangular.

4. The fluid delivery system of claim 1, wherein
the fluid passageway includes a first floor portion corresponding to the lowermost portion of the first passageway portion with respect to the direction of gravity of the earth,
the fluid passageway includes a second floor portion corresponding to the lowermost portion of the second passageway portion with respect to the direction of gravity of the earth, and
the first floor portion and the second floor portion are flush so as to form a continuous straight line.

5. The fluid delivery system of claim 4, wherein the first floor portion and the second floor portion reside in a plane that is angled relative to the horizontal in a range of (+) 45 degrees to (−) 35 degrees.

6. The fluid delivery system of claim 4, wherein the transition between the first passageway portion and the second passageway portion defines a corner.

7. The fluid delivery system of claim 1, wherein the transition between the first passageway portion and the second passageway portion defines a corner.

8. The fluid delivery system of claim 1, wherein
the filter is comprised of trap openings that are formed in a surface of the second passageway portion, and
each trap opening is configured to allow passage of particles therethrough under force of gravity.

9. The fluid delivery system of claim 1, wherein
the fluid passageway defines a floor corresponding to the lowermost portion of the fluid passageway with respect to the direction of gravity of the earth, and
the filter comprises trap openings defined by the floor and configured to allow passage of particles therethrough under force of gravity.

10. The fluid delivery system of claim 1, comprising a housing wherein
the fluid passageway is defined by an inner surface of the housing,
the fluid passageway defines a floor corresponding to the lowermost portion of the fluid passageway with respect to the direction of gravity of the earth,
the filter comprises trap openings that are provided in the floor and are configured to allow passage of particles therethrough under force of gravity,
the housing comprises a vacancy that underlies the trap openings, and
the vacancy is configured to receive and retain particles that pass through the trap openings.

11. A fluid delivery system, comprising:
a fluid passageway including
a first passageway portion having a first cross-section, and
a second passageway portion having a second cross-section, the second passageway portion adjoining the first passageway portion and being downstream of the first passageway portion with respect to the direction of fluid flow through the fluid passageway; and
a settlement filter that is disposed in the fluid passageway, the settlement filter comprising a transition from the first passageway portion to the second passageway portion and being configured to receive and retain particles therein,
wherein
the first cross-section and the second-cross section are perpendicular to a direction of fluid flow through the fluid passageway,
the first cross-section is different from the second cross section in shape or dimension, the difference in the first cross-section and the second cross section defining the transition,
the fluid passageway defines a floor corresponding to the lowermost portion of the fluid passageway with respect to the direction of gravity of the earth,
the settlement filter comprises a sieve disposed in the floor of the second passageway portion, and
the sieve is configured to allow passage of particles therethrough under force of gravity.

12. The fluid delivery system of claim 11, wherein the sieve is disposed at the transition from the first passageway portion to the second passageway portion and is includes trap openings.

13. The fluid delivery system of claim 12, wherein the settlement filter includes a trap housing that receives particles that have passed through the trap openings, the trap housing configured to retain particles received therein.

14. The fluid delivery system of claim 13, wherein the trap housing underlies the trap openings with respect to a direction of the force of gravity.

15. The fluid delivery system of claim 11, wherein the first cross-section has a first shape, the second cross-section has a second shape, and the first shape is different than the second shape.

16. The fluid delivery system of claim 11, wherein the first cross-section is circular and the second-cross section is rectangular.

17. The fluid delivery system of claim 11, wherein
the floor includes a first floor portion corresponding to the lowermost portion of the first passageway portion with respect to the direction of gravity of the earth,
the floor includes a second floor portion corresponding to the lowermost portion of the second passageway portion with respect to the direction of gravity of the earth, and
the first floor portion and the second floor portion are flush so as to form a continuous straight line.

18. The fluid delivery system of claim 17, wherein the first floor portion and the second floor portion reside in a plane that is angled relative to the horizontal in a range of (+) 45 degrees to (−) 35 degrees.

19. The fluid delivery system of claim 11, comprising a housing wherein the fluid passageway is defined by an inner surface of the housing.
